(19) United States
(12) Patent Application Publication
(10) Pub. No.: US 2026/0319204 A1
(43) Pub. Date: Oct. 15, 2026

(54) CABLE CLOSURE WITH SEALED ENDS

(71) Applicant: CommScope Technologies LLC, Claremont, NC (US)

(72) Inventor: Barry Wayne ALLEN, Siler City, NC (US)

(73) Assignee: CommScope Technologies LLC, Claremont, NC (US)

(21) Appl. No.: 19/484,180

(22) PCT Filed: May 16, 2024
(86) PCT No.: PCT/US2024/029786

§ 371 Date: Nov. 13, 2025

Related U.S. Application Data
(60) Provisional application No. 63/502,575, filed on May 16, 2023.

(51) Int. Cl. G02B 6/44; G02B 6/255

(52) U.S. Cl. CPC G02B 6/4444; G02B 6/2558; G02B 6/44785

(57) ABSTRACT

A closure for sealing cables that is easy to install and seal. In some embodiments the closure may be used for sealing optical splices between optical cables containing one or more optical fibers. In some embodiments, the closure can allow seals on opposite ends of the closure to be concurrently actuated by the application of a single fastener.

### CROSS REFERENCE TO RELATED APPLICATIONS

This application is being filed on May 16, 2024, as a PCT International Patent Application and claims the benefit of U.S. Provisional Patent Application No. 63/502,575 filed on May 16, 2023, the disclosure of which is incorporated herein by reference in its entirety.

### TECHNICAL FIELD

The present disclosure relates generally to closures. More particularly, the present disclosure relates to closures intended to seal around cables.

### BACKGROUND

Closures are used within the telecommunications field for a variety of functions. In some examples, closures may be used to protect and seal a cable such as an optical or electrical cable. In some examples, closures may be utilized to protect damaged or vulnerable cables. In other examples, closures may be used to protect a splice between optical fibers, electrical wiring, or any other type of splice arrangement known in the art. Examples of telecommunications closures are illustrated in U.S. Pat. No. 11,360,264 and PCT International Publication No. WO 2022/076722.

### SUMMARY

The present disclosure relates to a closure for use in telecommunications applications. In certain examples the closure is adapted for protecting cables and is configured to be easy to install and seal. In certain examples the closure is configured such that seals on opposite ends of the closure are concurrently actuated by the application of a single fastener. In certain examples, the closure can be used to enclose a splice such as an optical or electrical splice. In certain examples, the closure can be used to enclose an optical splice between first and second optical cables. In some examples the optical splice may be between a cable and a connectorized pigtail. In other examples, the closure may be used to protect damaged or broken cables.

One aspect of the present disclosure relates to a closure for housing an optical splice between optical fibers of first and second optical cables. The closure includes a closure housing that extends along a longitudinal axis between opposite first and second housing ends and defines an interior that extends between said first and second housing ends. The first and second housing ends respectively define first and second cable pass-through locations for receiving the first and second fiber optic cables respectively, with the closure housing defining an axial stop adjacent the second housing end. The closure further includes a frame adapted to be housed within the closure housing, the frame being configured to load into the closure housing through the first housing end and extending longitudinally between first and second frame ends such that the first and second frame ends are configured to be positioned adjacent the first and second housing ends respectively when the frame is housed within the closure housing. The closure further includes a first cable seal positioned adjacent the first frame end and a second cable seal positioned adjacent the second frame end. Furthermore, the closure includes a fastener for securing the frame within the closure housing. The closure housing and the fastener are relatively configured such that actuation of the fastener with respect to the closure housing drives the frame longitudinally toward the second housing end causing the second cable seal to be axially compressed between the second frame end and the axial stop and concurrently causing the first cable seal to be axially compressed between the fastener and the first frame end, wherein axial compression of the first and second cable seals causes the first and second cable seals to seal radially against an interior of the closure housing.

Another aspect of the present disclosure relates to a closure. The closure includes a closure housing that extends along a longitudinal axis between opposite first and second housing ends and defines an interior that extends between the first and second housing ends. The first and second housing ends respectively define first and second cable pass-through locations. The closure housing defines an axial stop adjacent the second housing end. The closure further includes a frame adapted to be housed within the closure housing, the frame being configured to load into the closure housing through the first housing end. The frame extends longitudinally between first and second frame ends configured to be respectively positioned adjacent the first and second housing ends when the frame is housed within the closure housing. The closure further includes a first cable seal positioned adjacent the first frame end and a second cable seal positioned adjacent the second frame end. Furthermore, the closure includes a fastener for securing the frame within the closure housing. The closure housing and the fastener are relatively configured such that actuation of the fastener with respect to the closure housing drives the frame longitudinally toward the second housing end causing the second cable seal to be axially compressed between the second frame end and the axial stop and concurrently causing the first cable seal to be axially compressed between the fastener and the first frame end. Axial compression of the first and second cable seals causes the first and second cable seals to seal radially against an interior of the closure housing.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

FIG. 1 depicts a perspective view of a closure in accordance with the principles of the present disclosure;

FIG. 2 depicts an exploded view of the closure of FIG. 1;

FIG. 3 depicts a further exploded view of the closure of FIGS. 1 and 2;

FIG. 4 is a cross-sectional view of a closure in accordance with the principles of the present disclosure illustrating the first step in the process of actuating a fastener;

FIG. 5 is a cross-sectional view depicting an intermediary step in the process of FIG. 4;

FIG. 6 is a cross-sectional view depicting the final step in the process of FIG. 4;

FIG. 7 depicts a perspective view of a closure in accordance with the principles of the present disclosure;

FIG. 8 is a cross-sectional view of another closure in accordance with the principles of the present disclosure illustrating the first step in an alternate process of actuating a fastener;

FIG. 9 is a cross-sectional view depicting an intermediary step in the process of FIG. 8;

FIG. 10 is a cross-sectional view depicting the final step in the process of FIG. 8;

FIG. 11 is a perspective view of another closure in accordance with the principles of the present disclosure illustrating the first step in an alternate process of actuating a fastener;

FIG. 12 is a perspective view depicting the final step in the process of FIG. 11;

FIG. 13 is a cross-sectional view depicting the first step in the process of compressing a seal in accordance with the principles of the present disclosure;

FIG. 14 is a cross-sectional view depicting an intermediary step in the process of FIG. 13

FIG. 15 is a cross-sectional view depicting the final step in the process of FIG.

FIG. 16 depicts a splice in accordance with the principles of the current disclosure;

FIG. 17 is a cross sectional view of the closure of FIG. 1;

FIG. 18 depicts a clasp in accordance with the principles of the present disclosure;

FIG. 19 is a perspective view depicting a step in the process of install the clasps of FIG. 18;

FIG. 20 is a perspective view depicting an intermediary step in the process of FIG. 19;

FIG. 21 is a perspective view depicting the final step in the process of FIG. 19;

FIG. 22 is a perspective view illustrating the relation between the closure of FIG. 1 and an optical splice;

FIG. 23 depicts a frame in accordance with the principles of the present disclosure;

FIG. 24 is a cross-sectional view depicting a closure with a spring in accordance with the principles of the present disclosure;

FIG. 25 is a perspective view of a mounted closure in accordance with the principles of the present disclosure;

FIG. 26 depicts a seal in accordance with the principles of the present disclosure;

FIG. 27 depicts a seal in accordance with the principles of the present disclosure;

FIG. 28 depicts a seal in accordance with the principles of the present disclosure;

FIG. 29 depicts a seal in accordance with the principles of the present disclosure;

FIG. 30 depicts a seal in accordance with the principles of the present disclosure;

FIG. 31 depicts an alternate orientation of the seal of FIG. 30;

FIG. 32 depicts the first step in the transformation process of the seal of FIGS. 30, 31;

FIG. 33 depicts an intermediary step in the transformation process of the seal of FIGS. 30, 31;

FIG. 34 depicts an additional intermediary step in the transformation process of the seal of FIGS. 30, 31;

FIG. 35 depicts the final step in the transformation process of the seal of FIGS. 30, 31.

### DETAILED DESCRIPTION

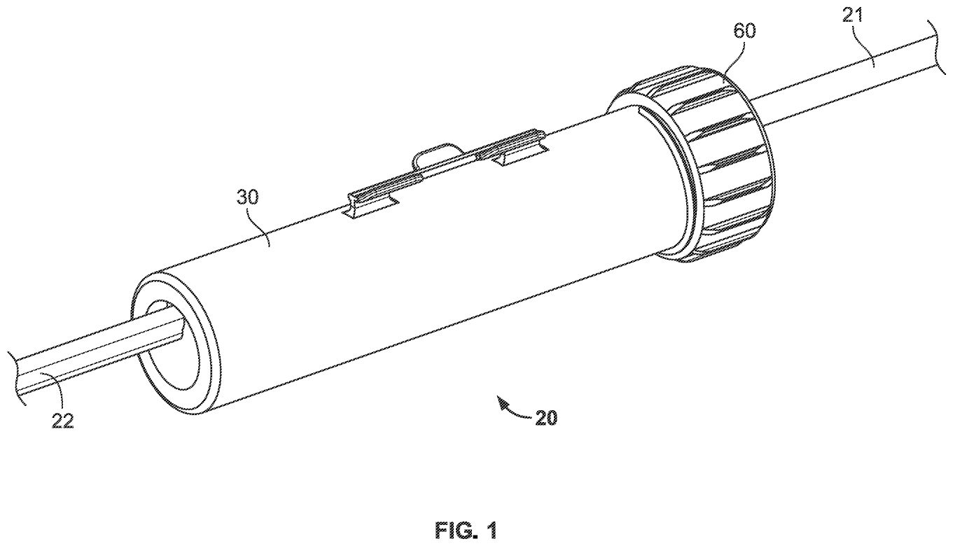

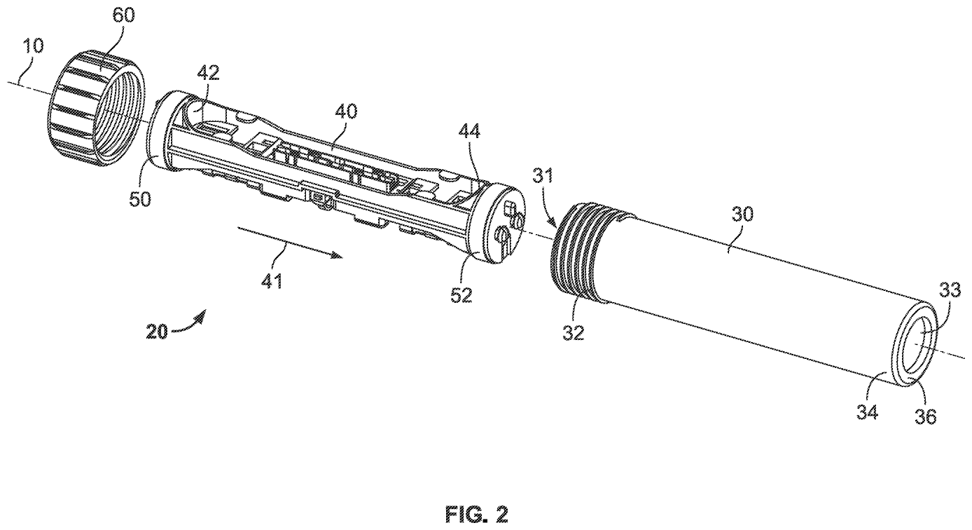

FIGS. 1-3 illustrate a closure 20 in accordance with the principles of the present disclosure for receiving one or more cables such as first and second cables 21, 22. In some examples the closure 20 may house an optical splice 29 between optical fibers 23 of the first cable 21 and the second cable 22, wherein the first and second cables 21, 22 are optical cables each including one or more optical fibers. The closure 20 includes a closure housing 30, a frame 40, a first cable seal 50 and a second cable seal 52, and a fastener 60.

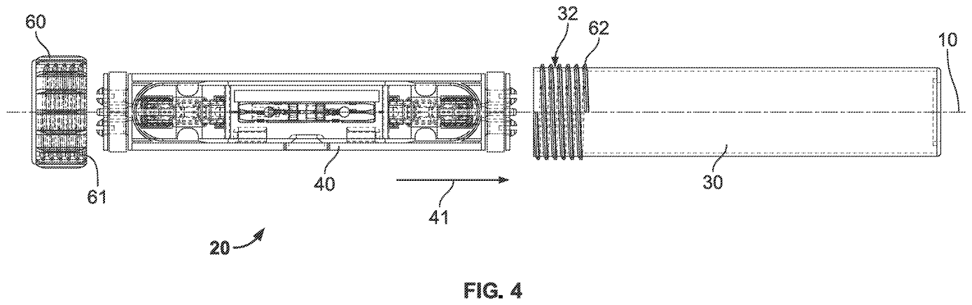

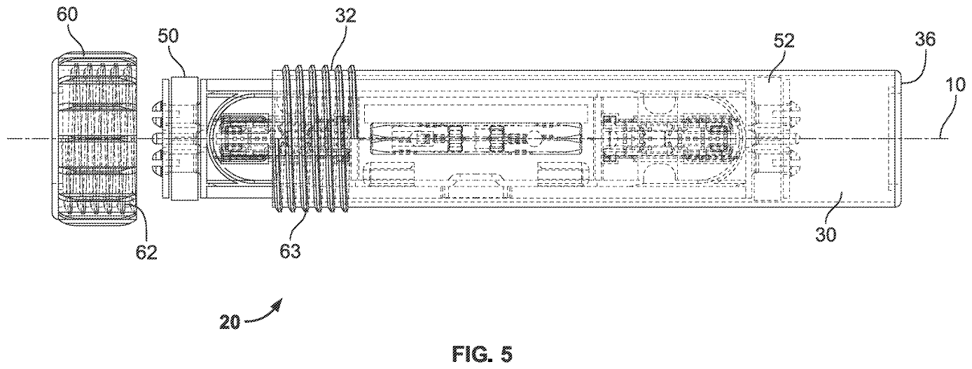

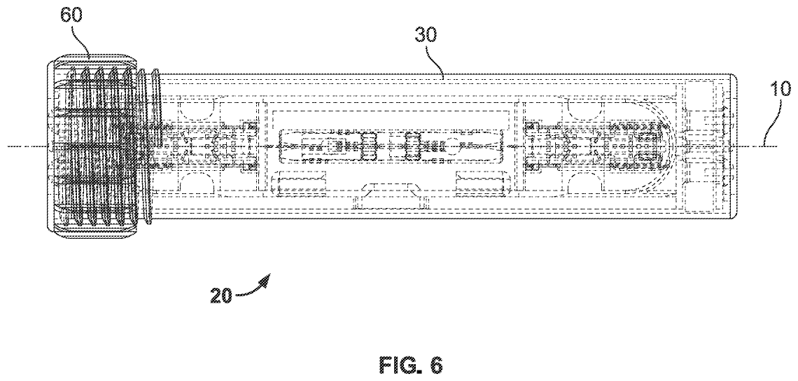

The closure housing 30 extends along a longitudinal axis 10 between a first housing end 32 and an opposite second housing end 34. The first housing end 32 and the second housing end 34 define the first cable pass-through location 31 and the second cable pass-through location 33 respectively. The first cable pass-through location 31 and the second cable pass-through location 33 are oriented to receive the first cable 21 and the second cable 22 respectively. The closure housing 30 defines an internal axial stop 36 adjacent the second housing end 34 for stopping axial movement of the frame 40 within the closure housing 30. The closure housing 30 is configured to allow insertion of the frame 40 into the closure housing 30 through the first housing end 32 (e.g., the first housing end lacks an internal axial stop). Thus, in the depicted example, the frame 40 can only be inserted into the closure housing 30 from one direction. FIGS. 4-6 show insertion of the frame 40 into the closure housing 30 in one direction (see insertion direction arrow 41). The first and second cable seals 50, 52 are configured for sealing the first and second housing ends 32, 34 by sealing radially between the closure housing 30 and the first and second cables 21, 22 routed through the first and second housing ends 32, 34. In some embodiments, the closure housing 30 is of unitary plastic construction. In some embodiments, the closure housing 30 may be a continuous molded tube of constant diameter. While depicted as a unitary structure, in other embodiments, the closure housing 30 may include two or more pieces which fit together to enclose the internal components of the closure 20.

The frame 40 extends longitudinally between a first frame end 42 and a second frame end 44 along the axis 10. The frame is configured such that first frame end 42 and the opposite second frame end 44 are respectively positioned adjacent to the first housing end 32 and the second housing end 34 when the frame 40 is housed within the closure housing 30. In some embodiments, the frame 40 may be of unitary plastic construction. In some embodiments the frame 40 may have additional components such as molded pathways, walls, spacers, adapter mounts, or any other structure known in the art. In some embodiments, the frame 40 may include or carry the cable anchors which may be comprised of plastic, metal, or any appropriate material known in the art. The cable anchors can include cable tie locations, clamps, cable clamping locations, fasteners, ties, clips, or other structures. The frame 40 can be a structural member configured for transferring axial load between the first and second frame ends 42, 44. In certain examples, the frame 40 can be configured for transferring compressive load between the first and second frame ends 42, 44 for compressing the first and second cable seals 50, 52. In certain examples, the frame 40 combined with the cable anchors for affixing the cables 21, 22 to the frame 40 can be configured for transferring compressive or tensile loading between the cables 21, 22 or to a structure to which the closure housing 30 is mounted.

The first cable seal 50 and the second cable seal 52 are adapted to be positioned adjacent the first and second frame ends 42, 44, respectively, when the closure 20 is assembled. In some embodiments, the cable seals 50, 52 are constructed of a sealing material wherein the-sealing material is an elastomeric material, a polymeric material, a thermo-plastic material, a rubber material, a silicone material, or any other suitable material known in the art. In one example embodiment, the cable seals 50, 52 can have a material composition including an elastomer such as a thermo-plastic elastomer (TPE) gel or silicone gel with a gel hardness between 70 to 110 grams. The cable seals 50, 52 are depicted each including at least one cable opening for passing a corresponding one of the cables 21, 22 through. In some embodiments the cable openings can have a push-through or alternatively a wrap-around configuration. The cable openings can have different shapes/profiles adapted to match the outer profiles of the cables intended to be routed therethrough.

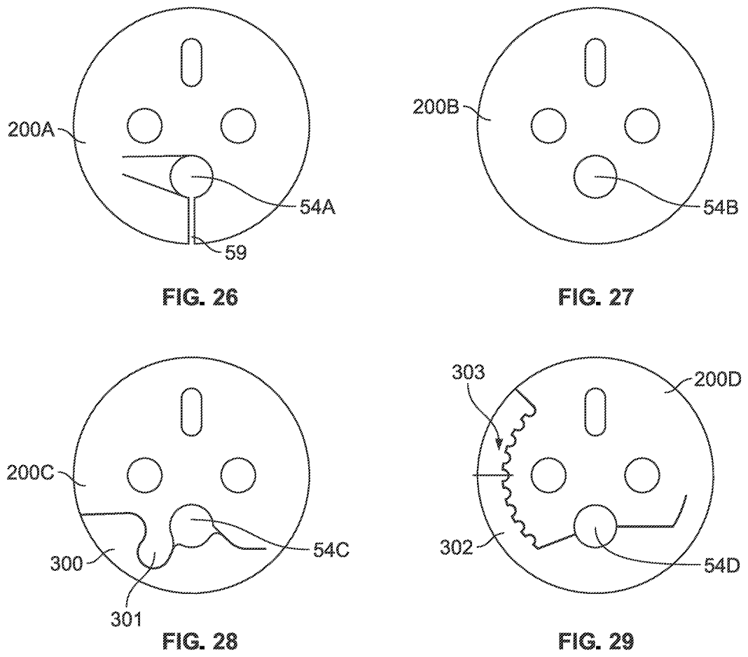

FIGS. 26-30 illustrate a variety of example seal configurations 200A-200E that are examples of configurations that can be used for the cable seals 50, 52. The seal configuration 200A of FIG. 26 includes a cable opening 54a (e.g., a round cable opening). The cable opening 54a has wrap-around configuration that allows a cable to be laterally inserted into the cable opening 54a through a slot 59 that extends from the cable opening 54a to an exterior of the seal configuration 200A. The seal configuration 200B of FIG. 27 includes a push-through opening 54b (e.g., a round push-through opening). The seal configuration 200C of FIG. 28 includes a wrap-around opening 54c defined in part by a flap 300 that can be opened to allow lateral access to the opening 54c and that is retained in a closed position by a lobed latch 301. The seal configuration 200D of FIG. 29 includes a wrap-around opening 54d defined in part by a flap 302 that can be opened to allow lateral access to the opening 54d and that is retained in a closed position by a toothed configuration 303.

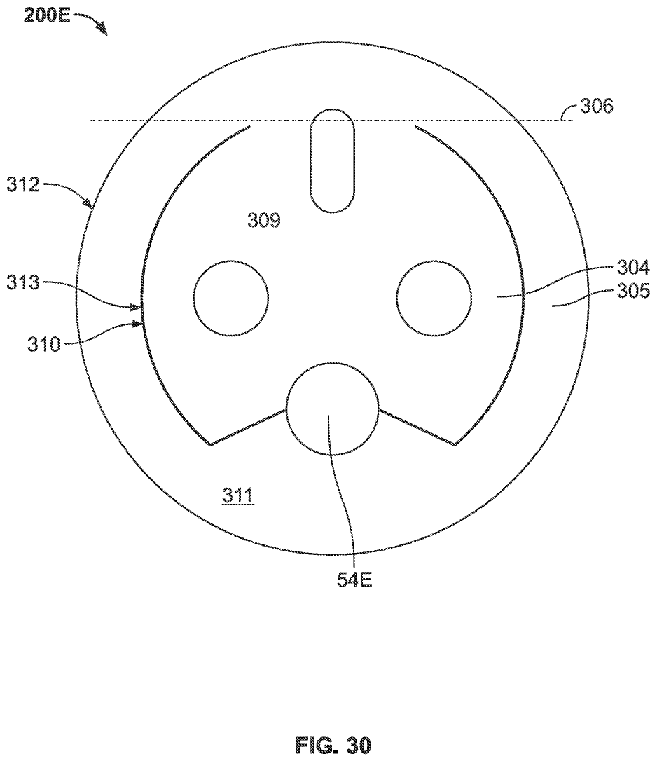

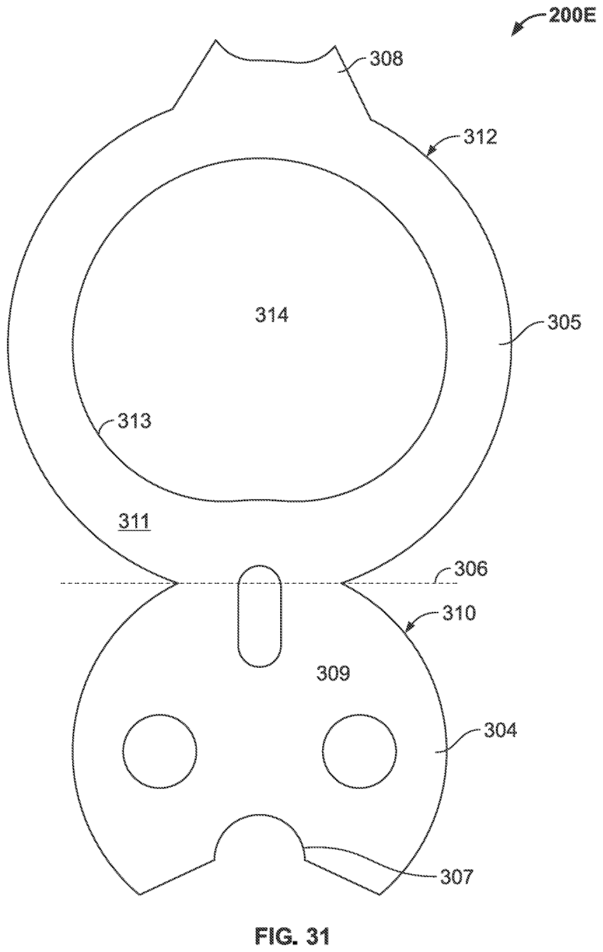

The seal configuration 200E of FIGS. 30 and 31 has a fold/flip over design, which acts to reduce strain on the gel during use. FIGS. 30 and 31 depict a fold over style seal configuration 200E in both flipped and unflipped orientation respectively. The seal configuration 200E is described in more detail below.

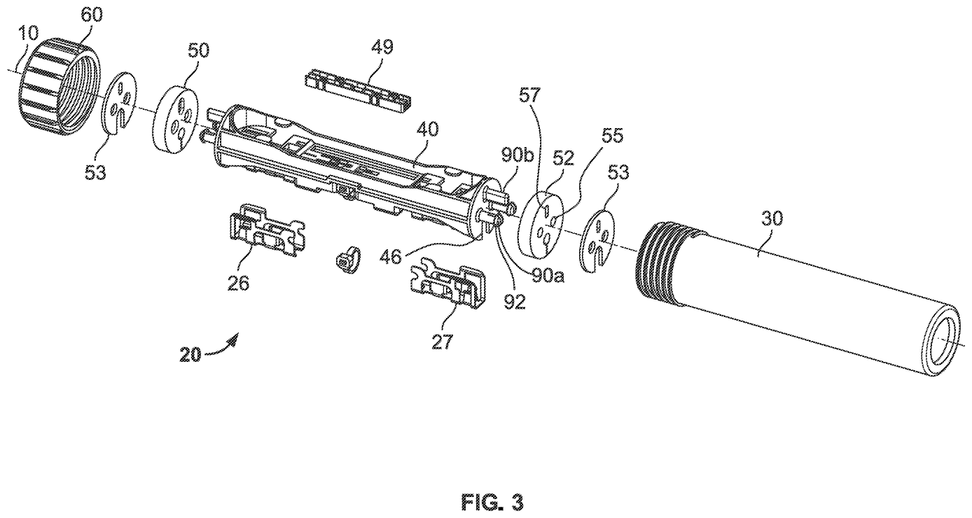

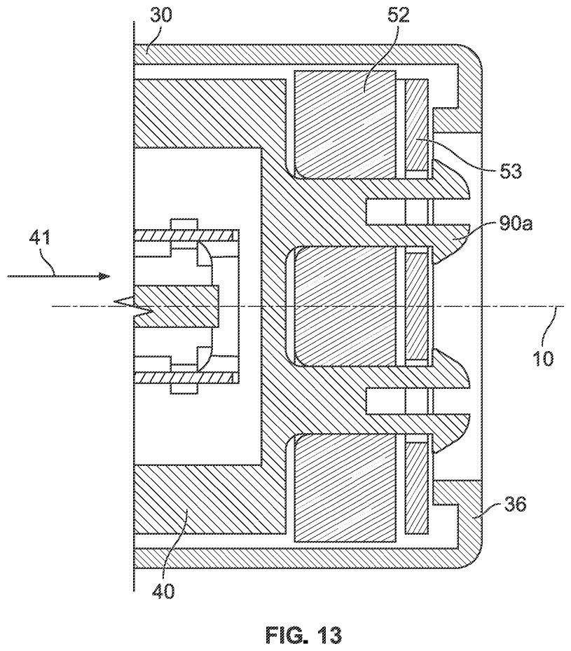

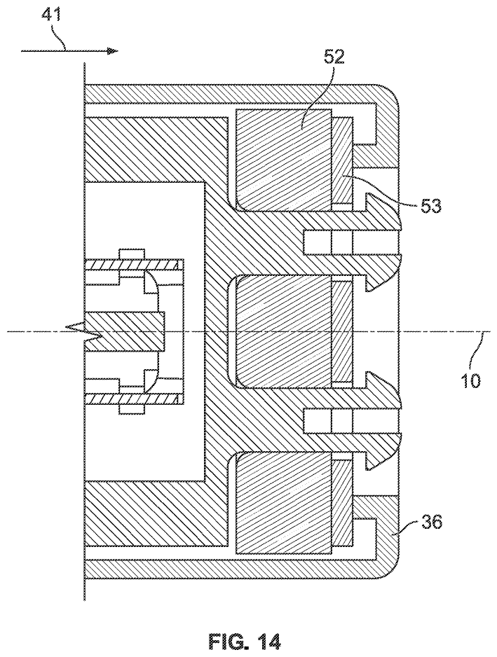

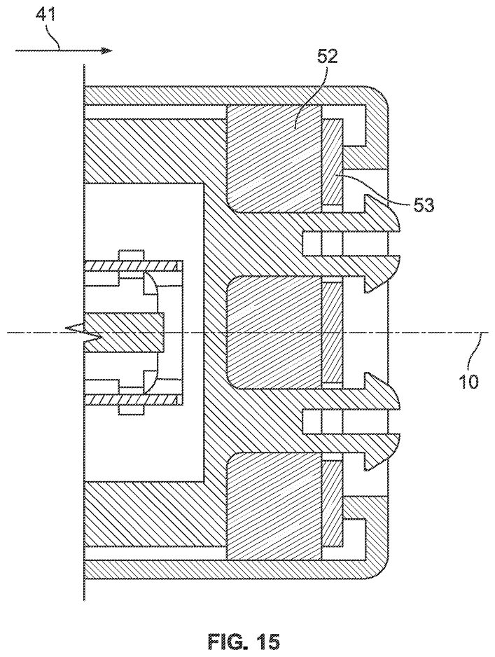

In some embodiments, the cable seals 50, 52 contain additional openings 55, 57 (shown in FIG. 3) for affixing the cable seals 50, 52 to the frame 40 via pins 90a, 90b (e.g., seal alignment pins, seal attachment pins, etc.) of the frame 40. The pins 90a, 90b may be of unitary construction with the frame 40 and are configured to extend through the openings 55. The pins 90a include enlarged heads 92 (shown in FIG. 3) which can have a resilient, deformable construction that allows the heads 92 to snap-through corresponding openings in retention washers 53 used to assist in securing the seals 50, 52 to the ends of the frame 40. In one example, the pins 90a can be referred to as snap-posts. The pins 90b can extend through the openings 57 can provide an alignment/keying function. The pins 90b and openings 57 each have an elongate profile. The seals 50, 52 are captured between the washers 53 and end surfaces/walls of the frame 40. It will be appreciated that the openings 55, 57 reduce the end surface area of the seals 50, 52. Therefore, by varying the size and number of the openings 55, 57 and the corresponding pins 90a, 90b that extend though the openings, the end surface areas of the seals 50, 52 can be varied to tune/modify the pressure applied to the seals during seal actuation (e.g., by reducing the surface area the seal pressure generated for a given axial load applied to the seal is increased and by increasing the surface area the seal pressure generated for a given axial load applied to the seal is decreased). The washers 53 are depicted in greater detail in FIG. 3. In some embodiments the washers 53 may be considered to be “floating” prior to actuation of the fastener 60 since seal retention regions of the pins 90a are longer than the combined thickness the washers and the uncompressed seals 50, 52. As the fastener 60 is actuated, the seals 50, 52 are axially compressed between the ends of the frame 40, the fastener 60 and the internal axial stop 36 of the closure housing 30 causing axial compression/loading of the seals 50, 52 and sealing of the ends of the closure about the cables 21, 22. This process is illustrated in greater detail in FIGS. 13-15 where axial compression and corresponding radial expansion of the second seal 52 at the second end 44 of the frame 40 is depicted as the second seal 52 is compressed between an axial end wall of the frame 40 and the internal axial stop 36 of the closure housing 30. The washers 53 assist in transferring axial load between the fastener 60 and the first seal 50 and between the internal axial stop 36 and the second seal 52.

FIGS. 4-6 illustrate the assembly of the closure 20. Prior to assembly, the fastener 60 is slid over the cable 21, and the closure housing 30 is inserted over the cable 22. The cables 21, 22 are inserted though their respective seals 50, 52 and the optical fibers of the cables 21, 22 can be spliced together. The optical splice can be secured in a splice package that is held in a splice holder mounted within the frame 40. Excess optical fiber can be managed (e.g., looped) on the frame and the cables 21, 22 can be anchored (e.g., axially fixed) to their respective ends 42, 44 of the frame 40. After the cables 21, 22 have been coupled to the frame 40, the second end 44 of the frame 40 is inserted in the direction 41 into the closure housing 30 through the first housing end 32. Insertion continues until the second end 44 of the frame 40 is adjacent the axial stop 36 at the second end 34 of the closure housing 30. The fastener 60 is then threaded on the first end 32 of the closure housing 30 to capture the frame 40 within the closure housing 30 and to cause axial compression of the first and second seals 50, 52 thereby effecting sealing around the cables 21, 22 at the first and second ends 32, 34 of the closure housing 30.

FIGS. 13-16 illustrate the compression of seal 52. As the frame 40 is driven towards the second housing end 34 via actuation (e.g., threading) of the fastener 60, the second cable seal 52 is compressed between the second frame end 44 and the second housing end 34 (e.g., the axial stop 36). Likewise, as the fastener 60 is actuated, the first cable seal 50 is compressed between the first frame end 42 and the fastener 60. Compression of the first cable seal 50 and the second cable seal 52 between the first frame end 42 and the fastener 60 and the second frame end 44 and the second closure housing end 34 respectively causes the first cable seal 50 and the second cable seal 52 to radially expand and thus seal radially against the interior of the closure housing 30. As the fastener is actuated, seals 50, 52 are compressed simultaneously with equal force.

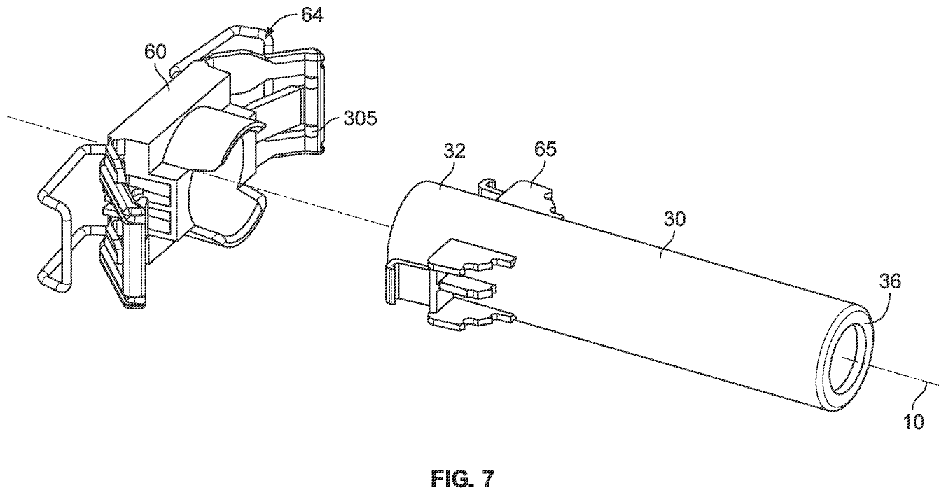

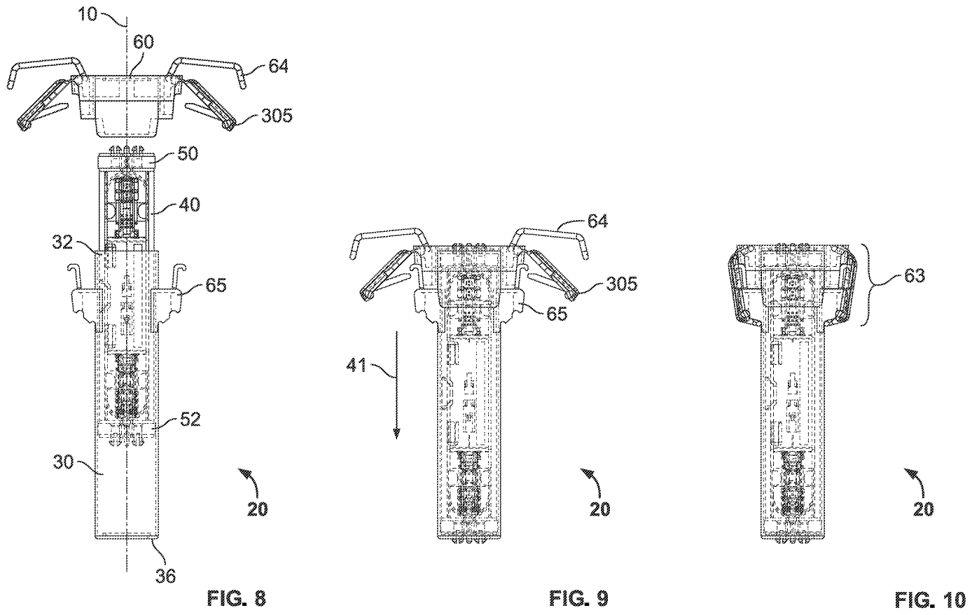

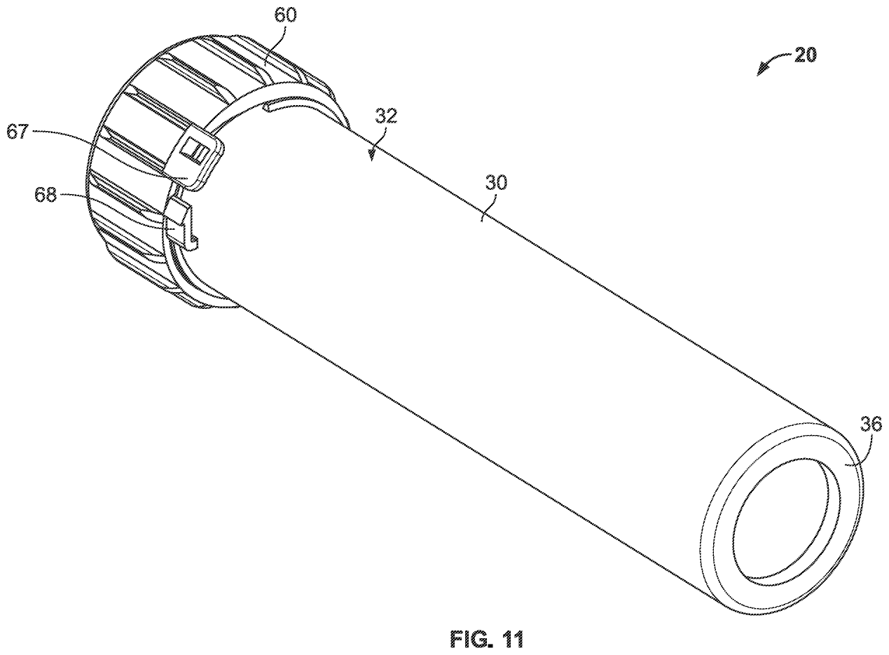

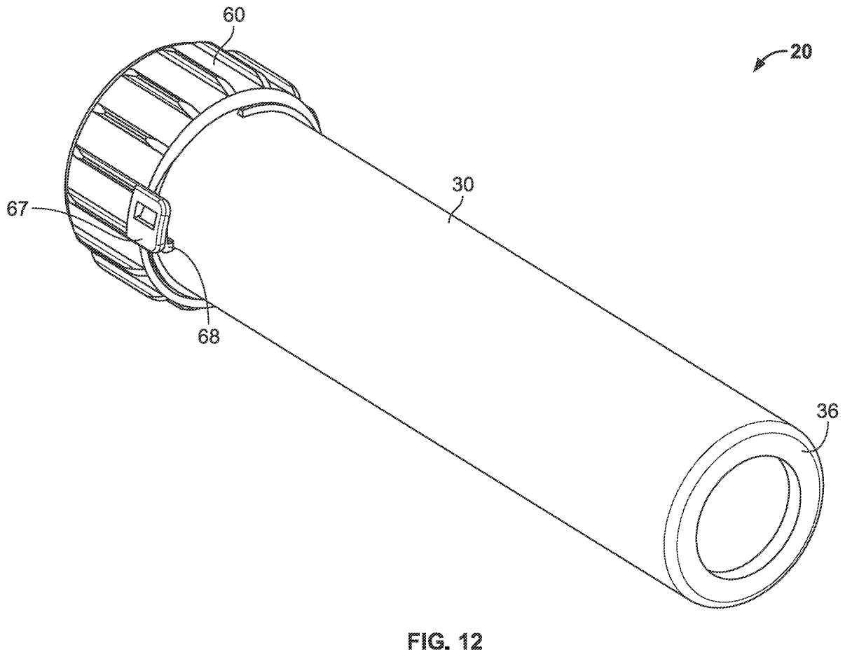

In one example, the fastener 60 has a unitary molded construction and may be constructed of plastic, metal, or any other material known in the art. To secure the frame 40 within the closure housing 30 and to cause compression of the first and second seals 50, 52, the fastener 60 is configured such that the actuation of the fastener 60 with respect to the closure housing 30 drives the frame 40 longitudinally along the axis 10 towards the second housing end 34. In some embodiments the fastener 60 is a threaded fastener containing the internal threads 61 that engage the external threads 62 at the first housing end 32, wherein the internal threads 61 are of unitary construction with the fastener 60, and likewise, the external threads 62 are of unitary construction with the closure housing 30 as shown in FIGS. 4-6. In some embodiments, internal threads 61 and external threads 62 may be modified buttress threading. In other embodiments the fastener 60 is actuated via a latch mechanism 63 as shown in FIGS. 7-10, which can have a lever and cam arrangement. The latch mechanism 63 further includes arms 64, clips 305 attached to the fastener 60 and a catch 65 which is of unitary construction with closure housing 30 at first housing end 32. In such examples, the fastener 60 is actuated via the engagement of the arms 64 with hooks of the catch 65 as shown in FIG. 9. When actuated in combination with the clips 305, the arms 64 pivot to an engaged position (see FIG. 10) along with the clips 305 to cause the fastener 60 to be driven longitudinally into the closure housing 30. In still other embodiments, the fastening arrangement includes a snap-lock arrangement as seen in FIGS. 11, 12, including a first snap fit part (e.g., a latch 67) which is of unitary construction with the fastener 60 and second snap-fit part (e.g., a catch 68) which is of unitary construction with closure housing 30 at first housing end 32. The snap-lock arrangement snaps to a locked configuration in which the snap-fit parts interlock together when the fastener 60 is fully threaded on the closure housing 30 to prevent unintentional unthreading of the fastener 60 In some examples, the engagement of the snap-lock arrangement may be accompanied by an audible click which indicates full tightening of the fastener 60.

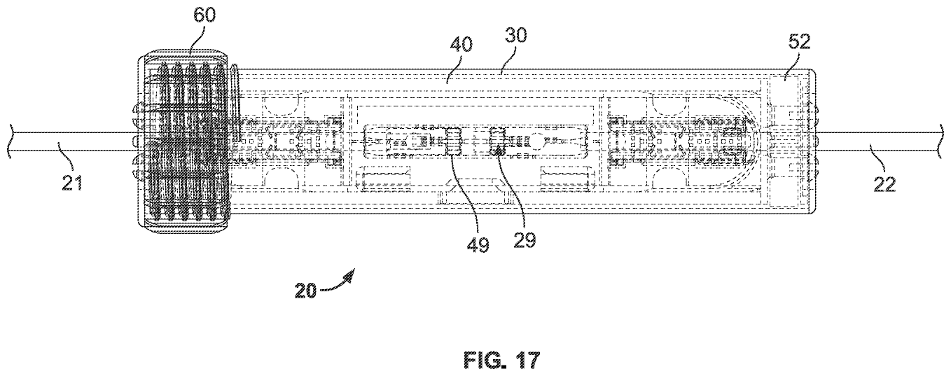

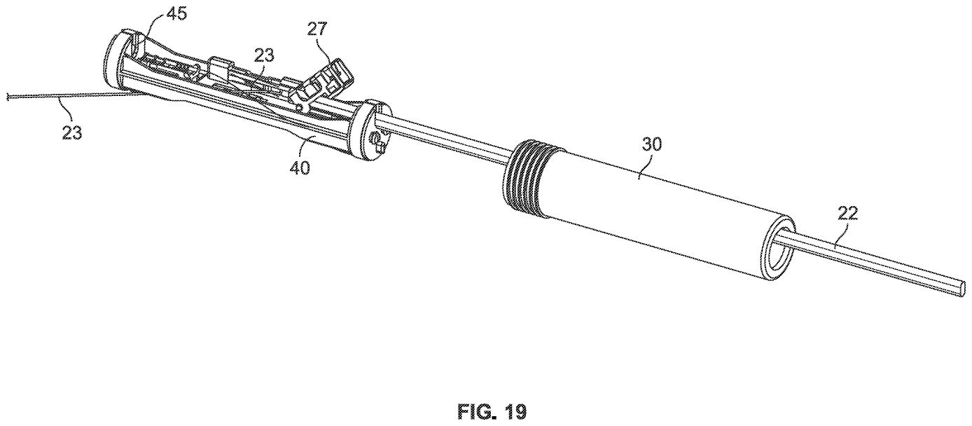

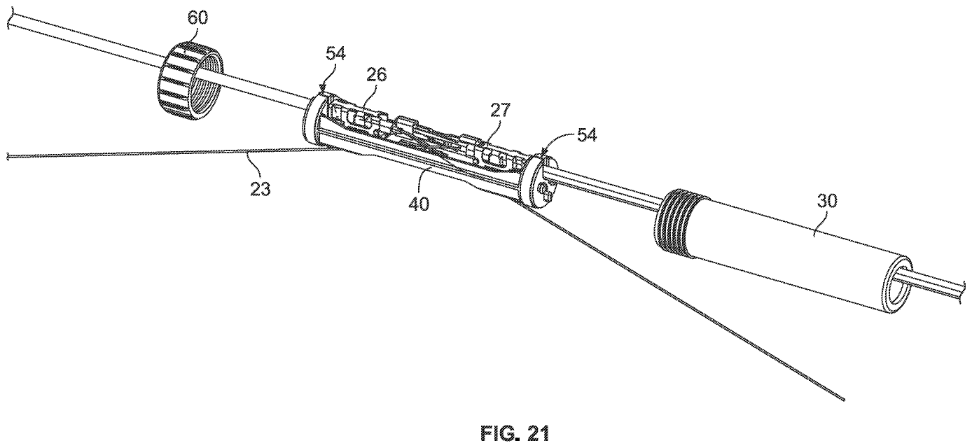

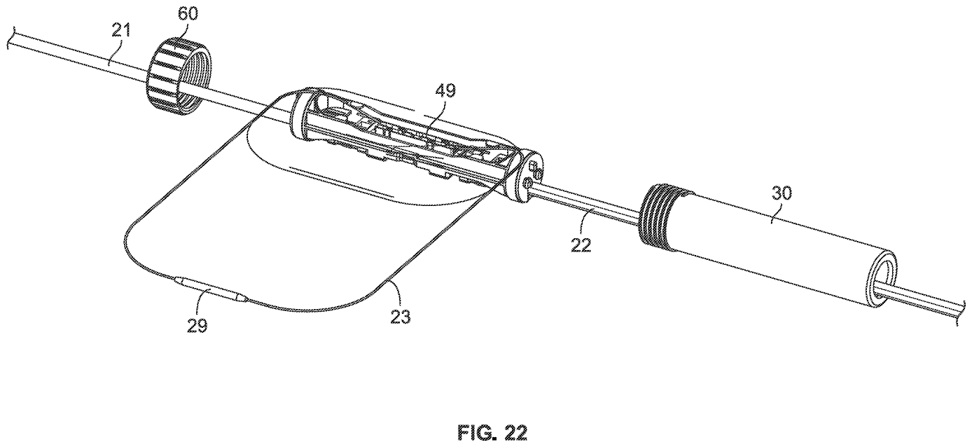

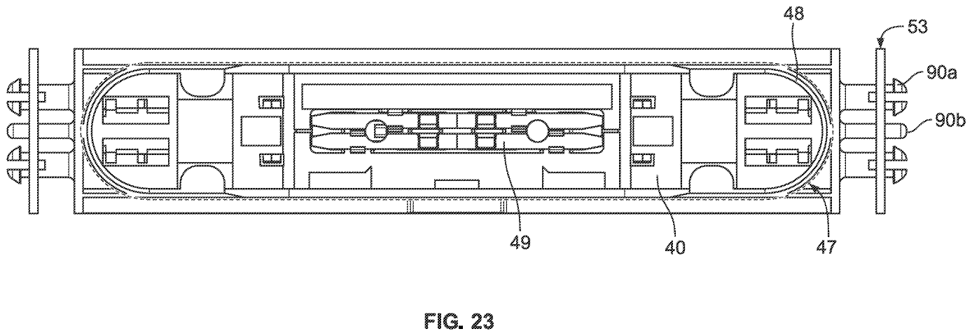

FIG. 17 illustrates a fully assembled example of the closure 20 with the first optical cable 21 and the second optical cable 22 enclosed. The first cable 21 passes through the fastener 60, the cable opening 54 (shown in FIG. 21) and a first frame slot 45 (shown in FIG. 19) into the interior of frame 40; likewise, the second cable 22 passes through the second closure housing end 34, the cable opening 54 and a second frame slot 46 (shown in FIG. 3) into the interior of frame 40. In some examples the cables 21, 22 are optical cables. In some examples the frame 40 contains the cable fixation region 72 adjacent to the first and second frame slots 45, 46 wherein the cables 21, 22 may be affixed for a variety of functions. In one example the cables 21, 22 may be affixed to aid in the protection of a splice 29. In some examples, the frame 40 may additionally include a splice mounting location 49 (shown in FIG. 17) for securing a splice 29 such as an optical splice. In some examples, the splice holder 73 is of unitary construction with the frame 40. In other examples the splice mounting location 49 is detachable from the frame 40. In some examples, the cables 21, 22 or the optical fibers 23 may be coiled within the limits of the frame 40. In some examples the cables 21, 22 or the optical fibers 23 may be coiled around splice mounting location 49 within the limits of the frame 40

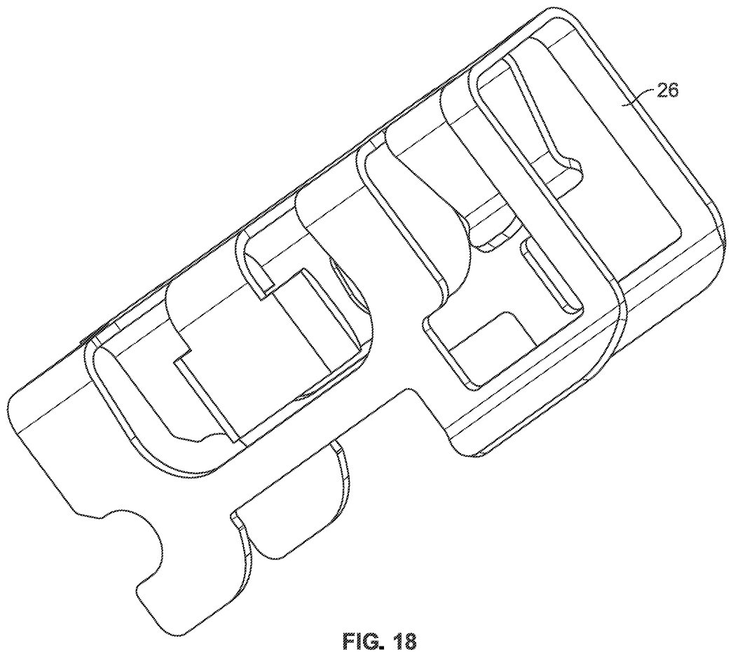

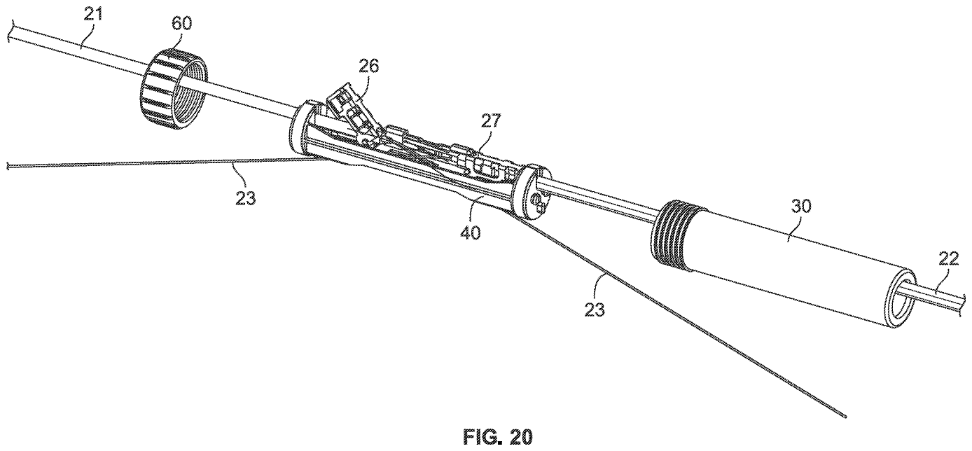

In some embodiments, the closure 20 further comprises the first cable anchor 26 (shown in FIG. 20) and the second cable anchor 27 (shown in FIG. 20) for affixing the first cable 21 and the second cable 22 to the frame 40. In some embodiments, the first cable anchor 26 and the second cable anchor 27 are cable clamps. In other embodiments the first and second cable anchors 26, 27 may be a cable tie location, a fastener, or any other appropriate fastener. In some examples, the first and second cable anchors 26, 27 may be comprised of plastic, metal or any other material known in the art. In some examples the first and second cable anchors 26, 27 may be detachably connected to the frame 40 via a hook or set of hooks, clips, screws or bolts, or any combination of these features. FIG. 18 depicts an exemplary cable anchor 26 in accordance with the present disclosure. Application of the first and second cable anchors 26, 27 is illustrated in FIGS. 19-21 . Further details of example clamps are illustrated in PCT International Publication No. WO 2022/076722 the disclosure of which is hereby incorporated herein by reference in its entirety.

In some embodiments, the frame 40 defines a fiber routing path 47 for storing the optical fibers 23 of the first cable 21 and the second cable 22 in a looped configuration on frame 40. In some embodiments, fiber routing path 47 includes curved bend radius limiters 48 about which optical fibers 23 may be looped. In some embodiments, fiber routing path 47 wraps about the splice mounting location 49.

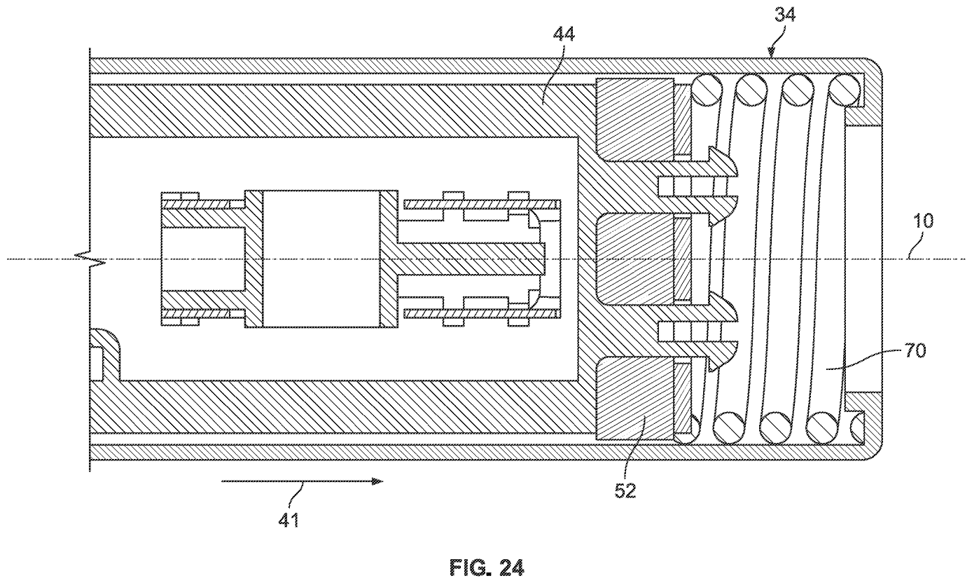

In some embodiments, the closure 20 further comprises a single spring 70 (FIG. 24) for maintaining spring load to the first and second cable seal 50, 52 in order to create axial compression of the first cable seal 50 and the second cable seal 52 after the fastener 60 is actuated.

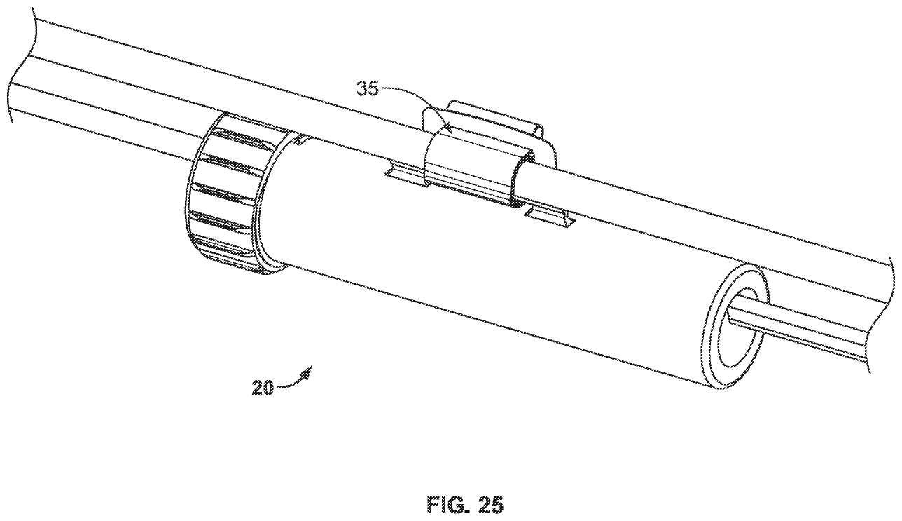

In some embodiments, the closure housing 30 further includes an exterior strap mount 35 for mounting the closure 20 to an appropriate surface (as shown in FIG. 25). In other embodiments, the closure 20 may be secured vie external hardware such as bolts, screws, cable ties, or other hardware. In other examples, the closure 20 may be free floating on one or more cables 21, 22. In some embodiments the closure 20 is oriented to be reduce the effects of flat drop bend bias.

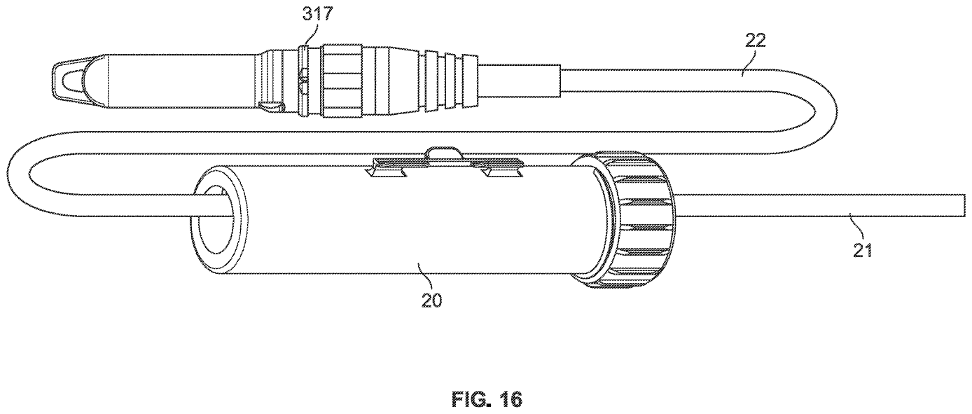

FIG. 16 depicts an example embodiment in which the first cable 21 is a main cable and the second cable 22 is a connectorized pigtail having one end spliced to the first cable 21 at the closure 20 and an opposite end connectorized by a hardened fiber optic connector 317.

FIGS. 30, 31 depict a cable seal 200E with a flipped and unflipped orientation as described above. The cable seal 220E includes a first seal portion 304 and a second seal portion 305 which are of unitary construction, the first and second seal portions being connected at a flip line 306. In order to transition between the flipped and unflipped orientations the first and second seal portions are configured to be flipped relative to one another across the flip line 306. While in the in the flipped orientation (as shown in FIG. 30), both the first and second seal portions 304, 305 are positioned on one side of the flip line 306, such that the first seal portion 304 is positioned within the second seal portion 305. The first and second seal portions 304, 305 respectively include the notches 307, 308 which align such that a first cable pass-through location 54E is defined between the notches 307, 308 while in the flipped orientation. While in the unflipped orientation (as shown in FIG. 31) the first seal portion 304 and second seal portion 305 are positioned on opposing sides of the flip line 306.

In some examples, the first seal portion 304 of cable seal 200E has a body 309 with an outer boundary 310. The second seal portion 305 includes a continuous band 311 with a first boundary 312 and a second boundary 313 which defines a main opening 314. In some examples, the continuous band 311 is ring-shaped. While cable seal 200E is in the unflipped orientation, the first boundary 312 of the second seal portion 305 defines the outer boundary of the second seal portion 305 and connects to the outer boundary 310 of the first seal portion 304 at flip line 306 to create a continuous boundary which defines the external boundary of cable seal 200E.

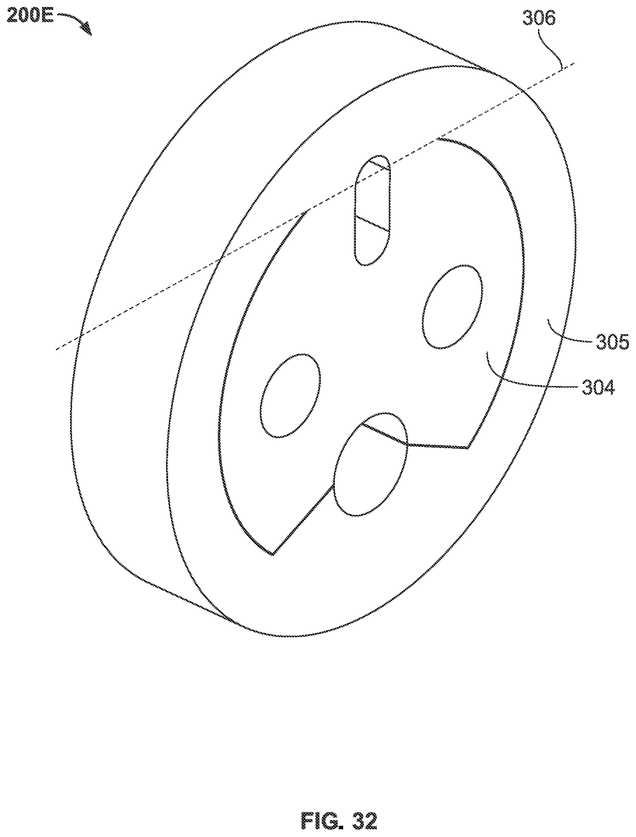

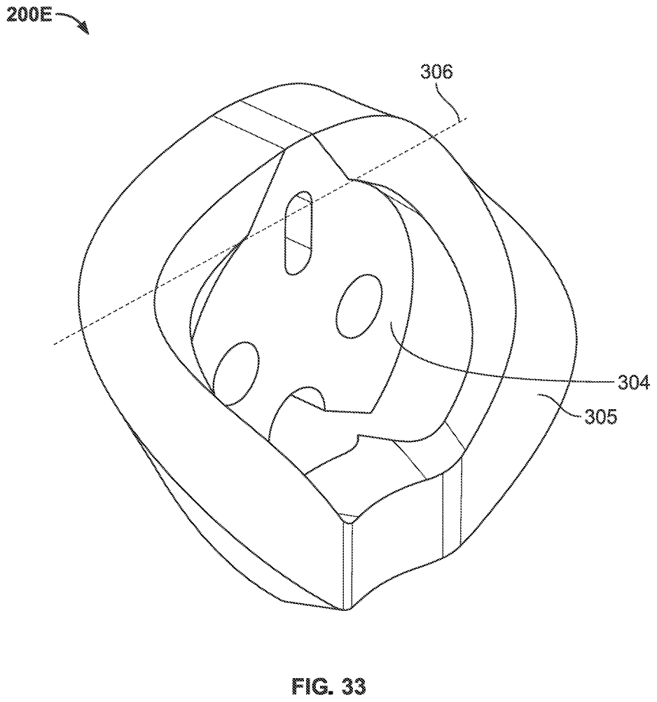

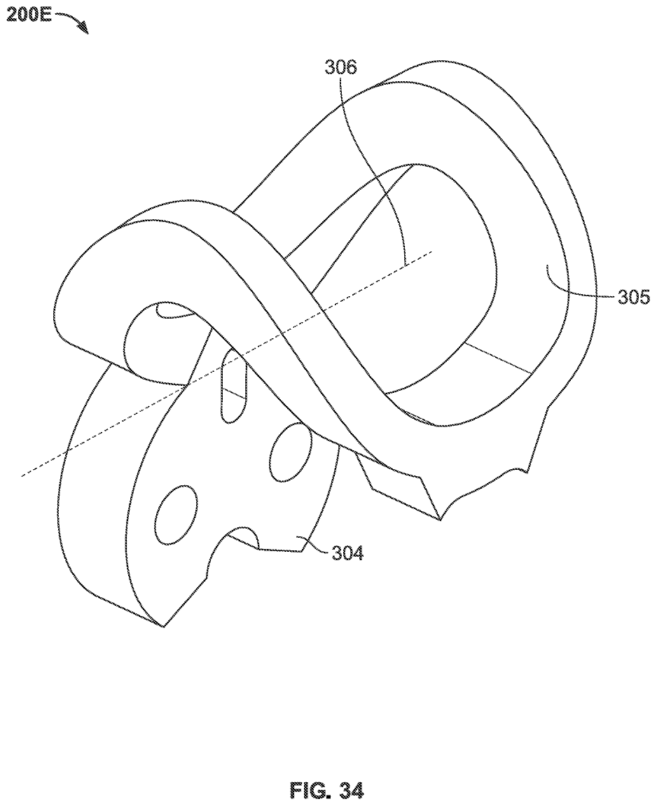

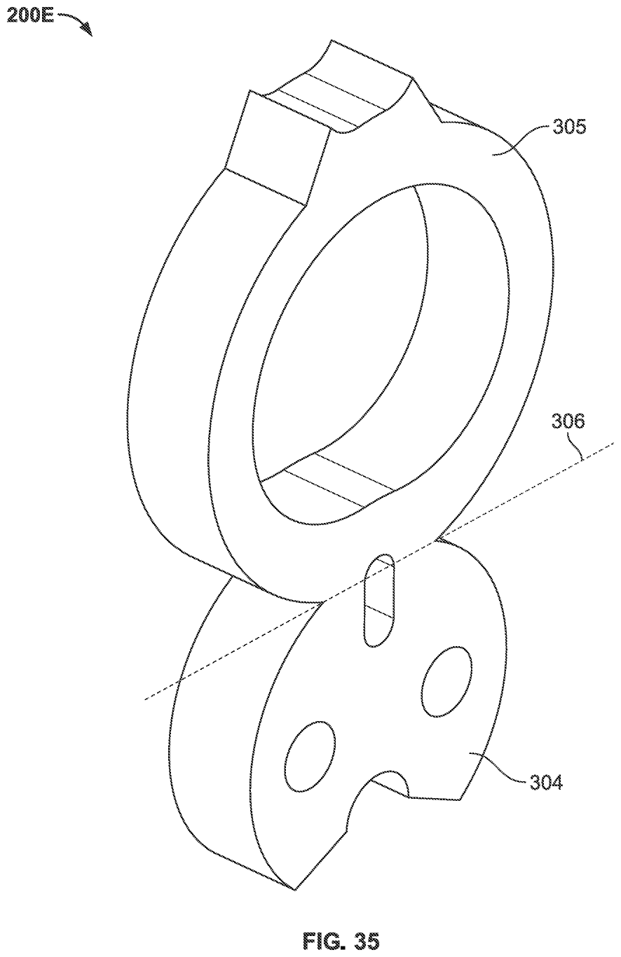

Conversely, while cable seal 200E is in the flipped orientation first seal portion 304 is secured within main opening 314 such that the first boundary 312 of the second seal portion 305 is adjacent to the outer boundary 310 of first seal portion 304 and the second boundary 313 of second seal portion 305 defines the external boundary of cable seal 200E. FIGS. 32-35 depict the transformation of the cable seal 200E from a flipped orientation to an unflipped orientation.

1. A closure for housing an optical splice between optical fibers of first and second optical cables, the closure comprising:
a closure housing that extends along a longitudinal axis between opposite first and second housing ends, the closure housing defining an interior that extends between the first and second housing ends, the first and second housing ends respectively defining first and second cable pass-through locations for respectively receiving the first and second fiber optic cables, the closure housing defining an axial stop adjacent the second housing end;
a frame adapted to be housed within the closure housing, the frame being configured to load into the closure housing through the first housing end, the frame extending longitudinally between first and second frame ends configured to be respectively positioned adjacent the first and second housing ends when the frame is housed within the closure housing;
a first cable seal positioned adjacent the first frame end and a second cable seal positioned adjacent the second frame end; and
a fastener for securing the frame within the closure housing, the fastener being configured such that actuation of the fastener with respect to the closure housing drives the frame longitudinally toward the second housing end causing the second cable seal to be axially compressed between the second frame end and the axial stop and concurrently causing the first cable seal to be axially compressed between the fastener and the first frame end, wherein axial compression of the first and second cable seals causes the first and second cable seals to seal radially against an interior of the closure housing.

2. The closure of claim 1, wherein the fastener is a threaded fastener.

3. The closure of claim 2, wherein the threaded fastener is a threaded cap having internal threads that engage external threads defined at the first housing end.

4. The closure of claim 3, further comprising a snap-latch that engages between the closure housing and the threaded cap for latching the threaded cap in a fully tightened position with respect to the closure housing.

5. The closure of claim 1, wherein the fastener is a pivotal cam latch.

6. The closure of claim 1, wherein the first and second frame ends include slots for respectively receiving the first and second optical cables.

7. The closure of claim 1, wherein the first and second frame ends include snap-posts that extend axially through the first and second cable seals.

8. The closure of claim 7, further comprising retention washers secured to the first and second frame ends for retaining the first and second cable seals respectively at the first and second frame ends.

9. The closure of claim 1, further comprising first and second cable anchors that attached to the frame for respectively affixing the first and second optical cables to the frame.

10. The closure of claim 9, wherein the first and second cable anchors are cable clamps.

11. The closure of claim 1, wherein the frame defines a fiber routing path for storing optical fibers corresponding to the first and second optical cables in a looped configuration on the frame.

12. The closure of claim 11, wherein the fiber storage region includes curved bend radius limiters about which the optical fibers are looped.

13. The closure of claim 12, wherein the frame defines an optical splice mounting location about which the fiber routing path loops.

14. The closure of claim 1, further comprising a spring for applying spring load to the first and second cable seals to cause axial compression of the first and second cable seals as the fastener is actuated.

15. The closure of claim 1, wherein the closure housing includes an exterior strap mount.

16. The closure of claim 1, wherein the axial stop is an annular shoulder.

17. A closure comprising:
a closure housing that extends along a longitudinal axis between opposite first and second housing ends, the closure housing defining an interior that extends between the first and second housing ends, the first and second housing ends respectively defining first and second cable pass-through locations, the closure housing defining an axial stop adjacent the second housing end;
a frame adapted to be housed within the closure housing, the frame being configured to load into the closure housing through the first housing end, the frame extending longitudinally between first and second frame ends configured to be respectively positioned adjacent the first and second housing ends when the frame is housed within the closure housing;
a first cable seal positioned adjacent the first frame end and a second cable seal positioned adjacent the second frame end; and
a fastener for securing the frame within the closure housing, the fastener being configured such that actuation of the fastener with respect to the closure housing drives the frame longitudinally toward the second housing end causing the second cable seal to be axially compressed between the second frame end and the axial stop and concurrently causing the first cable seal to be axially compressed between the fastener and the first frame end, wherein axial compression of the first and second cable seals causes the first and second cable seals to seal radially against an interior of the closure housing.

18. A cable seal comprising:
a seal body formed in a first state in which the seal body includes a first seal portion and a second seal portion unitarily connected at a flip line with the first and second seal portions positioned on opposite sides of the flip line, wherein in the first state the first seal portion is position outside the second seal portion, wherein the first and second seal portions are configured to be flipped relative to one another about the flip line to transition the seal body from the first state to a second state, wherein in the second state the first and second seal portions are both positioned at one side of the flip line and the first seal portion fits inside of the second seal portion, and wherein in the second state a first cable pass-through location is defined between the first and second seal portions.

19. The cable seal of claim 18, wherein the first seal portion defines an outer body having an outer boundary, wherein the second seal portion includes a continuous band that surrounds a main opening, and wherein the first seal portion fits within the main opening when the seal body is in the second state.

20. The cable seal of claim 19, wherein the continuous band includes first boundary and a second boundary that surround the main opening, wherein when the seal body is in the first state the first boundary is at an outside of the continuous band and the second boundary is an inside of the continuous band, wherein when the seal body is in the second state the first boundary is at the inside of the continuous band and the second boundary is at the outside of the continuous band, and wherein the first boundary opposes the outer boundary of the first seal portion when the seal body is in the second state with the first cable pass-through location being defined between the outer boundary of the first seal portion and the second boundary of the second seal portion.

21. The cable seal of claim 20, wherein the outer boundary of the first seal portion defines a first notch, wherein the first boundary of the second seal portion defines a second notch, and wherein when the seal body is in the second state the first and second notches align and cooperate to define the first cable pass-through location.

22. The cable seal of claim 20, wherein the continuous band is ring shaped and the first and second boundaries extend circumferentially about a center of the main opening.

23. The cable seal of claim 20, wherein the first seal portion defines second cable pass-through locations positioned inside the first seal portion and being fully defined by material of the first seal portion.
